(19) United States
(12) Patent Application Publication
(10) Pub. No.: US 2010/0064468 A1
(43) Pub. Date: Mar. 18, 2010

(54) FLAT WIPER BLADE FOR THE VEHICLE

(76) Inventor: Dong Hun Kang, Gyeonggi-do (KR)

Correspondence Address: Ballard Spahr LLP, SUITE 1000, 999 PEACHTREE STREET, ATLANTA, GA, 30309-3915, US

(21) Appl. No.: 12/517,240

(22) PCT Filed: Nov. 12, 2004
(86) PCT No.: PCT/KR2007/005675

§ 371 Date: Sep. 14, 2009

(30) Foreign Application Priority Data
Dec. 7, 2006 (KR) 20-2006-0031174

(51) Int. Cl. B60S 1/38

(52) U.S. Cl. 15/250.48

(57) ABSTRACT

The present invention relates to a flat wiper blade for a vehicle, and more particularly, to a flat wiper blade for a vehicle, which is constructed to allow a blade and spoilers to be integrally assembled with each other via an auxiliary coupler so that the blade and spoilers, fitted into and coupled to the auxiliary coupler, can be easily decoupled from the auxiliary coupler and replaced with new ones or different ones. According to the present invention, spoilers and a blade, which are fitted and coupled into an auxiliary coupler, can be easily replaced through simple manipulation. Spoilers having a variety of colors or patterns can be easily installed, so that a wiper blade for a vehicle can be decorated in various ways in conformity with the taste and character of a user. Also, since manufacturing and assembling processes can be simplified, manufacturing costs can be significantly reduced.

### TECHNICAL FIELD

The present invention relates to a flat wiper blade for a vehicle, and more particularly, to a flat wiper blade for a vehicle, which is constructed to allow a blade and spoilers to be integrally assembled with each other via an auxiliary coupler, so that the blade and spoilers fitted into and coupled to the auxiliary coupler can be easily decoupled from the auxiliary coupler and replaced with new ones or different ones.

In general, a wiper device is used to wipe rain or foreign matter from the windshield glass of a vehicle. In the wiper device, driving force generated by a wiper motor installed in the vehicle is transmitted to a wiper arm via a link mechanism, such that the wiper arm can be reciprocated within a predetermined angle. In particular, a wiper blade is detachably attached to the distal end of the wiper arm. The blade of the wiper blade is in close contact with the windshield glass of the vehicle. As the blade is reciprocated leftward and rightward, the blade wipes off rain or foreign matter from the windshield glass of the vehicle.

### BACKGROUND ART

In a conventional wiper blade, as shown in FIG. 5, a blade 2 is fitted through the slot defined in a leaf spring 1 and extending in the lengthwise direction of the leaf spring 1, and the leaf spring 1 is fitted into the grooves defined in a spoiler 3. Due to this fact, in the conventional wiper blade, not only are the manufacturing and assembling processes complicated, but also the replacement of the blade 2 cannot be easily conducted. Specifically, due to the presence of the slot defined along the center portion of the leaf spring 1, a problem is caused in which the leaf spring 1 is likely to be distorted, so that the force transmitted by the wiper arm cannot be evenly distributed over the entire length of the blade 2. Meanwhile, in the conventional wiper blade, since the replacement of the spoiler 3 cannot be easily conducted and a spoiler 3 generally having one color should be used until the entire wiper blade is replaced, limitations exist in that the wiper blade cannot be decorated to have various shapes or designs.

In consideration of these drawbacks, the inventor of the present invention has conducted research over a lengthy period, and resultantly devised a wiper blade for a vehicle, wherein an auxiliary coupler of a novel structure, into which a leaf spring can be inserted, and spoilers and a blade can be fitted and coupled, is employed, such that the spoilers and the blade can be integrally assembled with each other by the medium of the auxiliary coupler, and, as a result, the spoilers and the blade fitted and coupled into the auxiliary coupler can be replaced through simple manipulation, and such that, through ease of the replacement of the spoilers, a user can freely replace the spoilers with those having various colors or patterns in conformity with his or her taste or character, so that the wiper blade can be decorated to have various shapes or designs.

### DISCLOSURE OF INVENTION

### Technical Problem

Accordingly, the present invention has been made in an effort to solve the problems occurring in the related art, and an object of the present invention is to provide a flat wiper blade for a vehicle, in which spoilers and a blade fitted and coupled into an auxiliary coupler can be easily replaced through simple manipulation, so that spoilers having a variety of colors or patterns can be easily installed and the wiper blade for a vehicle can be decorated in various ways in conformity with the taste and character of a user, and in which manufacturing and assembling processes are simplified, so that manufacturing costs can be significantly reduced.

### Technical Solution

In order to achieve the above object, according to the present invention, there is provided a flat wiper blade for a vehicle, comprising a flat frame having a predetermined curvature; an auxiliary coupler having a through-opening which is defined through an upper part of the auxiliary coupler to extend in a lengthwise direction thereof, and into which the flat frame can be inserted and coupled, and a pair of bent locking portions which are formed at a lower part of the auxiliary coupler to extend in the lengthwise direction thereof; a blade having projecting locking portions which are formed at an upper end thereof and can be fitted into the bent locking portions of the auxiliary coupler, the blade being brought into direct contact with a windshield glass of a vehicle to perform a wiping function; spoilers each having locking grooves which are defined on inner wall surfaces of a lower part thereof to extend in the lengthwise direction of the spoiler, and into which the auxiliary coupler can be fitted and coupled; and a bracket coupled to an intermediate part of the auxiliary coupler, wherein the flat frame is coupled into the through-opening of the auxiliary coupler, the auxiliary coupler is fitted into the locking grooves of the spoilers, and the blade is coupled into the bent locking portions of the auxiliary coupler, whereby the blade and the spoilers are integrally assembled with each other by the medium of the auxiliary coupler.

Preferably, the flat wiper blade further comprises end caps locked to respective ends of the auxiliary coupler, wherein each end cap has locking protuberances formed on an inside lower end thereof such that the locking protuberances are locked and secured into locking holes which are defined adjacent to both widthwise end portions on each end of the auxiliary coupler.

More preferably, the spoilers are structured to be able to be imparted with various colors, and various contents such as ads, telephone numbers, images, photographs, characters, etc. can be printed on the spoilers, so that, after a user unlocks the end caps, the spoilers can be replaced with those having different colors or printed with different material in conformity with the user's taste or need.

Most preferably, the flat frame is made of carbon steel, and the auxiliary coupler and the spoilers are made of soft plastic.

According to an embodiment of the present invention, the spoiler is formed to have a triangular sectional shape.

Preferably, the flat wiper blade according to the present invention further comprises a bracket cover locked to the bracket from the top to cover the bracket.

### Advantageous Effects

Thanks to the features of the present invention, spoilers and a blade, which are fitted and coupled into an auxiliary coupler, can be easily replaced through a simple manipulation. Spoilers having a variety of colors or patterns can be easily installed, so that a wiper blade for a vehicle can be decorated in various ways in conformity with the taste and character of a user. Also, since manufacturing and assembling processes are simplified, manufacturing costs can be significantly reduced.

### BRIEF DESCRIPTION OF THE DRAWINGS

FIG. 1 is a perspective view illustrating a flat wiper blade for a vehicle in accordance with an embodiment of the present invention;

FIG. 2 is an exploded perspective view illustrating the flat wiper blade for a vehicle in accordance with the embodiment of the present invention;

FIG. 3 is a sectional view taken along the line A-A of FIG. 1;

FIG. 4 is a perspective view for reference, illustrating respective structures for locking an end cap and a bracket cover according to the embodiment of the present invention; and

FIG. 5 is an exploded perspective view illustrating a conventional flat wiper blade for a vehicle.

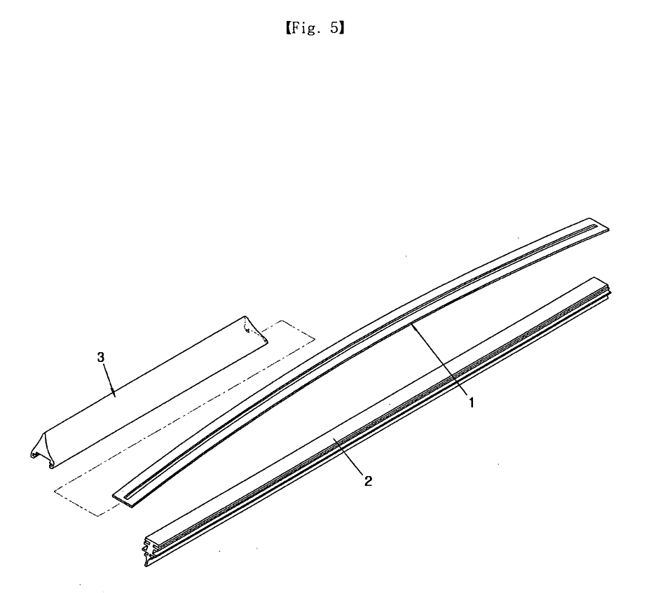

### DESCRIPTION OF REFERENCE NUMERALS FOR MAIN PARTS IN DRAWINGS

10: auxiliary coupler 12: through-opening

14: bent locking portions 16: locking holes

20: spoiler 22: locking grooves

30: flat frame 40: blade

42: projecting locking portions

50: bracket

52: coupling shaft 60: end cap

62: locking protuberances 70: bracket cover

### BEST MODE FOR CARRYING OUT THE INVENTION

Hereafter, a preferred embodiment of the present invention will be described with reference to the attached drawings.

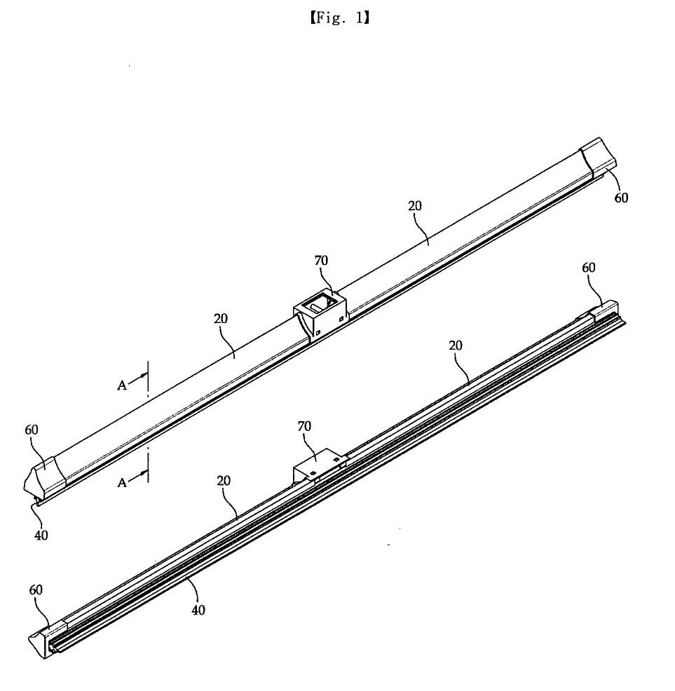

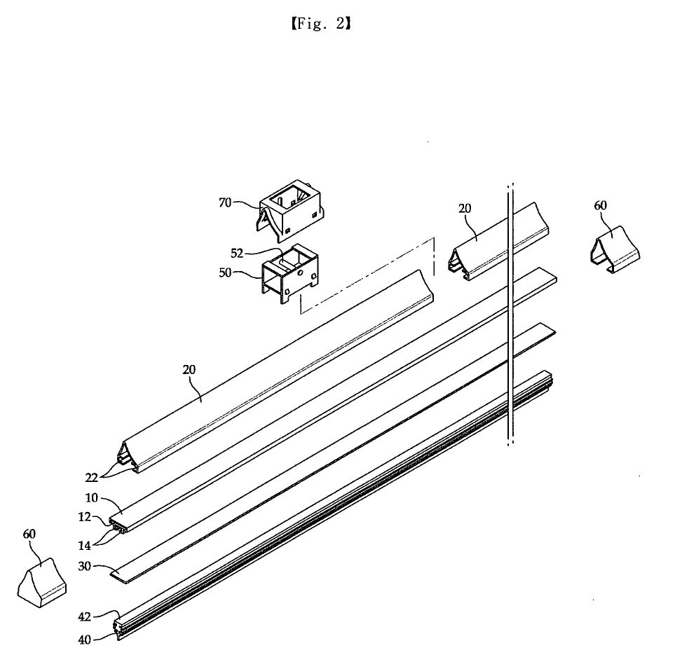

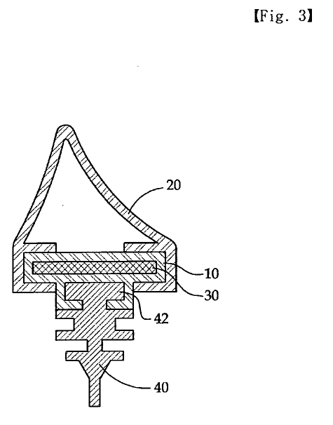

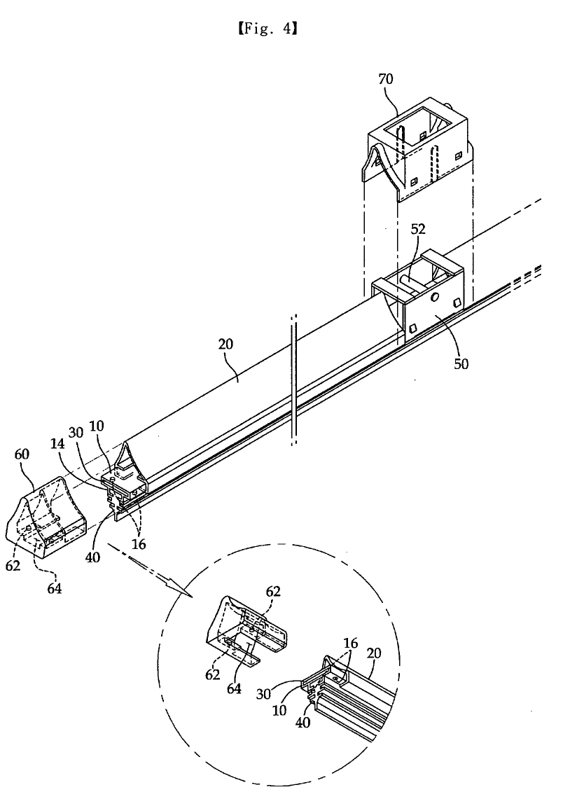

FIG. 1 is a perspective view illustrating a flat wiper blade for a vehicle in accordance with an embodiment of the present invention. FIG. 2 is an exploded perspective view illustrating the flat wiper blade for a vehicle in accordance with the embodiment of the present invention. FIG. 3 is a sectional view taken along the line A-A of FIG. 1. FIG. 4 is a perspective view for reference, illustrating respective structures for locking an end cap and a bracket cover according to the embodiment of the present invention.

Referring to FIGS. 1 through 3, a flat wiper blade for a vehicle in accordance with an embodiment of the present invention includes a flat frame 30 having a predetermined curvature, an auxiliary coupler 10 having a through-opening 12 which is defined through the upper part of the auxiliary coupler 10 to extend in the lengthwise direction thereof, and into which the flat frame 30 can be inserted and coupled, and a pair of bent locking portions 14 which are formed at the lower part of the auxiliary coupler 10 to extend in the lengthwise direction thereof, a blade 40 having projecting locking portions 42 which are formed at the upper end thereof and can be fitted into the bent locking portions 14 of the auxiliary coupler 10, the blade 40 being in direct contact with the windshield glass of a vehicle to perform a wiping function, spoilers 20 each having locking grooves 22 which are defined on the inner wall surfaces of the lower part thereof to extend in the lengthwise direction of the spoiler 20 and into which the auxiliary coupler 10 can be fitted and coupled, and a bracket 50 coupled to the intermediate part of the auxiliary coupler 10.

The flat frame 30 is fitted and coupled into the through-opening 12 in the auxiliary coupler 10, and is designed to have a predetermined curvature so that the wiper blade can be stably brought into close contact with the windshield glass of the vehicle. Therefore, the flat frame 30 (or the auxiliary coupler 10, into which the flat frame 30 is fitted and coupled) transmits the force, which is transmitted thereto from a wiper arm, to the windshield glass of the vehicle in an evenly distributed manner, so that not only can the degree of close contact of the wiper blade with the windshield glass be increased, but also the wiper blade is prevented from floating while the vehicle travels at a high speed. Preferably, the flat frame 10 is made of carbon steel so as to be prevented from being distorted and to secure a predetermined strength and returning force. The blade 40 is brought into direct close contact with the windshield glass of the vehicle to perform a function of wiping off rain or foreign matter. The blade 40 has the projecting locking portions 42 on the upper end thereof.

Referring to FIG. 2, the auxiliary coupler 10 has the through-opening 12 defined through the upper part thereof and extending in the lengthwise direction thereof, and the pair of bent locking portions 14 formed at the lower part thereof and extending in the lengthwise direction thereof. The flat frame 30 is inserted into the through-opening 12, and the blade 40 is fitted into the pair of bent locking portions 14. Preferably, the auxiliary coupler 10 is made of soft plastic.

As shown in FIG. 1, the bracket 50 is coupled to the intermediate part of the auxiliary coupler 10. The bracket 50 has a coupling shaft 52. A center clip (not shown), which can be compatibly coupled with every kind of existing wiper arm and may have various shapes, is fitted around the coupling shaft 52. Accordingly, the wiper blade according to the present invention can be easily mounted to every kind of existing vehicle by the medium of the center clip, which is fitted around the coupling shaft 52.

Referring to FIG. 4, end caps 60 are locked to both ends of the auxiliary coupler 10. Each end cap 60 has locking protuberances 62 formed on the inside lower end thereof, and locking holes 16 are defined adjacent to both widthwise end portions on each end of the auxiliary coupler 10, onto which the end cap 60 is fitted and coupled. An opening 64 is defined in the lower end of the end cap 60 to be open in the direction in which the end of the auxiliary coupler 10 is fitted into the end cap 60, such that when the end cap 60 is fitted onto the end of the auxiliary coupler 10, the bent locking portions 14 of the auxiliary coupler 10 can be fitted into the opening 64. Hence, when the end caps 60 are fitted onto respective ends of the auxiliary coupler 10, as the locking protuberances 62 of each end cap 60 are engaged and locked into the locking holes 16 of the auxiliary coupler 10, the end cap 60 can be secured to the auxiliary coupler 10.

Each of the spoilers 20 has the locking grooves 22 defined on the inner wall surfaces of the lower part thereof and extending in the lengthwise direction thereof. The auxiliary coupler 10 is fitted and coupled into the locking grooves 22 of the spoilers 20. Thus, when a user pulls the spoilers 20 toward respective ends of the auxiliary coupler 10, the spoilers 20 can be easily removed from the auxiliary coupler 10. Preferably, the spoiler 20 is formed to have a triangular sectional shape. Due to this fact, the wiper blade is kept in close contact with the windshield glass of the vehicle by the wind flowing along the outer surfaces of the spoilers 20. That is to say, if the vehicle travels with the wiper blade, having the spoilers 20 structured in this way, mounted to the vehicle, the wind blowing toward the rear of the vehicle flows along the inclined surfaces of the spoilers 20. At this time, the wind flowing along the inclined surfaces of the spoilers 20 presses the wiper blade against the front windshield glass of the vehicle. As a result, since the wiper blade is maintained in a state in which it is in close contact with the front windshield glass of the vehicle, the wiper blade is prevented from vibrating or floating when the vehicle travels at a high speed, and at the same time, rain or foreign matter can be effectively removed from the front windshield glass of the vehicle. Preferably, the spoilers 20 are made of soft plastic.

Meanwhile, the spoilers 20 are structured to be capable of having various colors, and various content, such as ads, telephone numbers, images, photographs, characters, etc., can be printed on the spoilers 20. Therefore, when a user replaces the spoilers 20 with those having various patterns or designs in conformity with his or her taste or need, the wiper blade can be decorated in various ways. In other words, after the user unlocks the end caps 60 and removes the spoilers 20 by pulling them from the auxiliary coupler 10, the user can fit and couple other spoilers 20, having different colors or printed with different contents, onto the auxiliary coupler 10, because the replacement of the spoilers 20 can be easily conducted.

Referring to FIG. 4, a bracket cover 70 is locked to the bracket 50 from the top to cover the bracket 50. Preferably, a pair of complementary locking members (for example, locking projections and locking holes) is provided to the bracket cover 70 and the bracket 50 so that they can be easily assembled with and disassembled from each other. The bracket cover 70 covers end portions of the spoilers 20, which extend toward the bracket 50, and thereby prevents the entire outer appearance of the wiper blade from being marred by the spoilers 20, which are coupled to both ends of the bracket 50.

Although a preferred embodiment of the present invention has been described for illustrative purposes, it is to be appreciated that the present invention is not limited to the aforementioned embodiment, and that various modifications, additions and substitutions can be made by a person having ordinary knowledge in the art to which the present invention pertains, without departing from the technical concept of the present invention. Therefore, those skilled in the art will appreciate that the construction of the flat wiper blade illustrated in the drawings can be changed and modified without departing from the spirit and scope of the present invention as disclosed in the accompanying claims.

1. A flat wiper blade for a vehicle, comprising: a flat frame having a predetermined curvature; an auxiliary coupler having a through-opening which is defined through an upper part of the auxiliary coupler to extend in a lengthwise direction thereof, and into which the flat frame can be inserted and coupled, and a pair of bent locking portions, which are formed in a lower part of the auxiliary coupler to extend in the lengthwise direction thereof; a blade having projecting locking portions which are formed at an upper end thereof and can be fitted into the bent locking portions of the auxiliary coupler, the blade being in direct contact with a windshield glass of a vehicle to perform a wiping function; spoilers each having locking grooves which are defined on inner wall surfaces of a lower part thereof to extend in a lengthwise direction of the spoiler, and into which the auxiliary coupler can be fitted and coupled; and a bracket coupled to an intermediate part of the auxiliary coupler, wherein the flat frame is coupled into the through-opening of the auxiliary coupler, the auxiliary coupler is fitted into the locking grooves of the spoilers, and the blade is coupled into the bent locking portions of the auxiliary coupler, whereby the blade and the spoilers are integrally assembled with each other via the auxiliary coupler.

2. The flat wiper blade according to claim 1, further comprising: end caps locked to both ends of the auxiliary coupler, wherein each end cap has locking protuberances formed on an inside lower end thereof such that the locking protuberances are locked and secured into locking holes which are defined adjacent to both width wise end portions on each end of the auxiliary coupler.

3. The flat wiper blade according to claim 2, wherein the spoilers are structured to be capable of having various colors, and various content, such as ads, telephone numbers, images, photographs, characters, etc., can be printed on the spoilers, so that, after a user unlocks the end caps, the spoilers can be replaced with those having different colors or printed with different content, in conformity with the user's taste or need.

4. The flat wiper blade according to claim 1, wherein the flat frame is made of carbon steel, and the auxiliary coupler and the spoilers are made of soft plastic.

5. The flat wiper blade according to claim 1, wherein the spoiler is formed to have a triangular sectional shape.

6. The flat wiper blade according to claim 1, further comprising: a bracket cover, locked to the bracket from the top to cover the bracket.

7. The flat wiper blade according to claim 2, wherein the spoiler is formed to have a triangular sectional shape.

8. The flat wiper blade according to claim 3, wherein the spoiler is formed to have a triangular sectional shape.

9. The flat wiper blade according to claim 4, wherein the spoiler is formed to have a triangular sectional shape.

10. The flat wiper blade according to claim 2, further comprising: a bracket cover, locked to the bracket from the top to cover the bracket.

11. The flat wiper blade according to claim 3, further comprising: a bracket cover, locked to the bracket from the top to cover the bracket.

12. The flat wiper blade according to claim 4, further comprising: a bracket cover, locked to the bracket from the top to cover the bracket.
